(19) United States
(12) Patent Application Publication
(10) Pub. No.: US 2002/0150518 A1
(43) Pub. Date: Oct. 17, 2002

(54) Gas treatment device

(76) Inventors: Dagan W. Brush, Flint, MI (US); Eric J. Lesher, Holly, MI (US); Robert N. Wyland, Davison, MI (US)

Correspondence Address: Vincent A. Cichosz, Delphi Technologies, Legal Staff, Mail Code 480-414-420, P.O. Box 5052, Troy, MI, 48007-5052, US

(21) Appl. No.: 09/834,983

(22) Filed: Apr. 13, 2001

(51) Int. Cl. B01D 53/34; B21D 39/00

(52) U.S. Cl. 422/180; 29/428

(57) ABSTRACT

The gas treatment device comprises a shell concentrically disposed around a catalyst substrate comprising a catalyst, and a mat support material disposed between the catalyst substrate and shell, and concentrically around the catalyst substrate. A retainer ring comprising a first wall and a second wall connected by a bridge is concentrically disposed around the catalyst substrate. The retainer ring is in operable communication with the shell to form an interference fit, and also contacts the mat support material. The retainer ring can further comprise at least two segments.

### BACKGROUND

Gas treatment devices, such as catalytic converters, evaporative emission devices, hydrocarbon scrubbing devices, and the like, are universally employed to catalytically treat environmentally unfriendly components of automobile exhaust gas streams. These gas treatment devices employ catalysts supported by substrates to catalytically treat the exhaust gas streams. The substrates tend to be frangible and have coefficients of thermal expansion differing markedly from their treatment device containers. As a result, the mounting means of the substrate must provide resistance to mechanical shock due to impact and vibration, and to thermal shock due to thermal cycling. Both thermal and mechanical shock may cause deterioration of the mat support material, which once started, quickly accelerates and ultimately renders the device useless.

Various intumescent and non-intumescent sheets, or mat support materials have been found adequate as mounting materials for this purpose. However, with smaller, four cylinder engines running at higher rotational velocities and catalytic converters being moved forward for quicker light-off times, present mounting materials are being subjected to much higher exhaust temperatures. Under these conditions, over a period of time, mat support materials can be eroded.

Generally, a catalytic converter 20 utilizes a pair of dual-walled end cone assemblies 22 welded onto a shell 30 as a means for attaching the catalytic converter to the mobile vehicle's exhaust system (See FIGS. 1 and 2). Typically, the dual-walled end cone assemblies 22 comprise both an outer end cone 24 and an inner end cone 26. The inner end cone 26 can reduce the likelihood of mat erosion and thermal deterioration of a mat support material 28 during operation of the catalytic converter 20. However, the inner end cone 26 is welded into outer end cone 24 using a costly and inefficient manufacturing procedure. As a result, alternatives are being sought for the dual-walled end cone assemblies.

Some catalytic converter designs, and especially designs without dual-walled end cone assemblies, incorporate an edge protection material around the intake area of the catalyst substrate to reduce thermal deterioration of the mat support material. For instance, a stainless steel wire mesh fabric or screen, as described in U.S. Pat. No. 5,008,086 to Merry, is disposed concentrically about the exhaust gas inlet of a catalyst substrate. Wire rope edge sealants, like the type disclosed in Merry, prove somewhat effective. However, when employing a wire rope edge sealant, there is still a noticeable amount of mat support material erosion, and an increased temperature gradient that forms circumferentially across the first inch of the shell due to the conduction of heat through the wire rope. In addition, incorporating edge protection materials requires additional labor, which also increases manufacturing costs. Furthermore, edge protection materials increase the overall weight of the catalytic converter as well as its cost. This, in turn, ultimately reduces the likelihood that the customer's packaging requirements can be met.

### SUMMARY

The drawbacks and disadvantages of the prior art are overcome by the gas treatment device, and method of making the same. The gas treatment device comprises a shell concentrically disposed around a catalyst substrate comprising a catalyst, and a mat support material disposed between the catalyst substrate and shell, and concentrically around the catalyst substrate. A retainer ring comprising a first wall and a second wall connected by a bridge is concentrically disposed around the catalyst substrate. The retainer ring is in operable communication with the shell to form an interference fit, and also contacts the mat support material. The retainer ring can further comprise at least two segments.

The method of manufacturing the gas treatment device comprises disposing a catalyst substrate comprising a catalyst concentrically within a shell. A mat support material is concentrically disposed around the catalyst substrate. A retainer ring is disposed in operable communication with the shell to form an interference fit therewith. The retainer ring comprises a first wall that contacts the mat support material, a second wall disposed on a side of the shell opposite the catalyst substrate, and a bridge connecting the first wall and second wall. An interference fit is formed between the shell and retainer ring, while the retainer ring contacts the mat support material.

The gas treatment device also comprises a shell concentrically disposed around a catalyst substrate comprising a catalyst. A mat support material is disposed between the catalyst substrate and shell, and concentrically around the catalyst substrate. A retainer ring comprising a first wall and a second wall connected therein by a bridge having a plurality of apertures is concentrically disposed around the catalyst substrate. The outer surface of the shell contacts an inner surface of the second wall. An end of the shell contacts the bridge. The first wall contacts the mat support material. An exhaust system component is disposed in operable communication with said shell and said retainer ring.

The gas treatment device further comprises a means for catalytically treating gas, a means for reducing erosion of the mat support material, and a means for forming an interference fit. The means for catalytically treating gas comprises a shell concentrically disposed about a catalyst substrate comprising a catalyst, and a mat support material disposed between the shell and catalyst substrate, and around catalyst substrate. The means for reducing erosion of the mat support material comprises a retainer ring comprising a first wall and a second wall connected by a bridge, wherein the retainer ring is concentrically disposed around the catalyst substrate, in contact with the mat support material, and in operable communication with the shell to form an interference fit. The means for forming an interference fit comprises an outer surface of the shell is disposed in contact with an inner surface of the second wall and the bridge.

The above described and other features are exemplified by the following figures and detailed description.

### BRIEF DESCRIPTION OF THE DRAWINGS

Referring now to the figures wherein the like elements are numbered alike:

FIG. 1 is a side view of a catalytic converter of the prior art;

FIG. 2 is a cross-sectional view taken from line 2-2 of the catalytic converter of FIG. 1;

FIG. 3 is a top view of an exemplary embodiment of a retainer ring;

FIG. 4 is a cross-sectional view of the retainer ring of FIG. 3;

FIG. 5 is a perspective view of an exemplary embodiment of a retainer ring segment;

FIG. 6 is a cross-sectional top view taken of the catalytic converter of FIG. 3, employing two retainer ring segments as illustrated in FIG. 5;

FIG. 7 is a perspective view of an exemplary embodiment of an exhaust manifold-catalytic converter assembly;

FIG. 8 is a side view of the exhaust manifold-catalytic converter assembly of FIG. 7;

FIG. 9 is another side view having partial cross-sectional views of the catalytic converter shown in FIGS. 7 and 8;

FIG. 10 is an enlarged partial cross-sectional view of area 10-10 of FIG. 7;

FIG. 11 is a side view of a catalytic converter employing an end cone assembly, an end plate, and two retainer rings; and

FIG. 12 is an enlarged partial cross-sectional view of area 12-12 of FIG. 11.

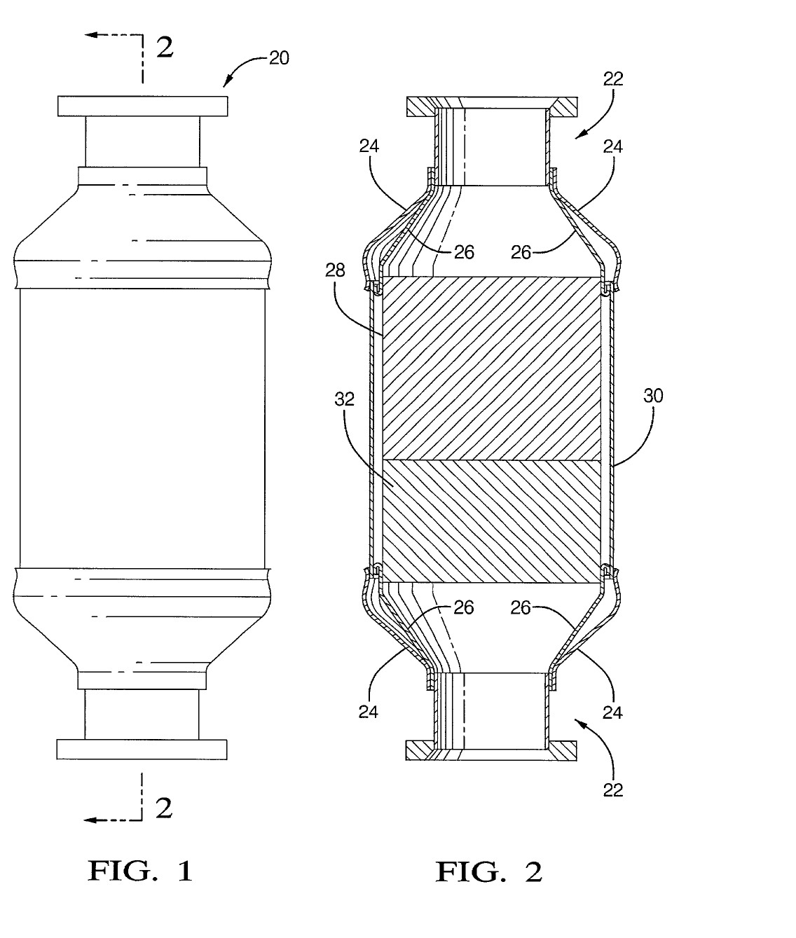

### DETAILED DESCRIPTION

The treatment device can comprise a catalytic converter, evaporative emission device, hydrocarbon scrubbing device, and the like. For purposes of illustration, the exemplary embodiments of the retainer ring are described with various catalytic converter assemblies. The catalytic converter comprises a catalyst supported on a catalyst substrate. The catalyst substrate is disposed within a shell with a mat support material disposed there between. At one or both ends of the shell, and within an exhaust system component (e.g., an exhaust manifold, end cone, connecting pipe, exhaust pipe, coupling apparatus, flexible coupling apparatus, and combinations comprising at least one of the foregoing exhaust system components), is disposed a retainer ring(s), that (1) shields the shell from high temperature exhaust gas that can overheat the mat support material causing expansion thereof and potential shell deformation; (2) reduces the temperature of the catalytic converter's outer surface to prevent thermal deformation of the shell; (3) seals the leading edge of the mat support material, protecting the mat support material from thermal deterioration cause by impinging exhaust gas; and (4) retains the mat support material.

The retainer ring, which can be formed by one or more segments that form an at least partially “U”-shaped cross-sectional geometry, with an overall geometry (e.g., a top view geometry) that corresponds to the shape of the catalytic converter shell, can be disposed so that an end of the shell and at least a portion of the mat support material are disposed between the walls of the retainer ring. The U-shaped cross-sectional geometry of the retainer ring forms an interference fit with the shell. By allowing the retainer ring to overlap the shell in an interference fit, an exhaust manifold can be secured to both the shell and retainer ring, and welded or otherwise secured in place to form a gas tight seal.

Catalytic converters catalytically treat environmentally unfriendly exhaust gas components using a catalyst supported on one or more catalyst substrates. The catalyst substrate can comprise any material designed for use in a spark ignition, Otto type, or diesel engine environment, and have the following characteristics: (1) capable of operating at exhaust temperatures (e.g., typically up to about 1,000° C.); (2) capable of withstanding exposure to hydrocarbons, nitrogen oxides, carbon monoxide, carbon dioxide, sulfur and/or sulfur oxides; and (3) having sufficient surface area and structural integrity to support the desired catalyst. Some possible materials include cordierite, silicon carbide, metallic foils, alumina sponges, porous glasses, and the like, and mixtures comprising at least one of the foregoing materials. Some ceramic materials include “HONEY CERAM”, commercially available from NGK-Locke, Inc, Southfield, Mich., and “CELCOR”, commercially available from Coming, Inc., Coming, N.Y.

Although the catalyst substrate can have any size or geometry, the size and geometry are preferably chosen to optimize surface area in the given catalytic converter design parameters. Typically, the catalyst substrate has a honeycomb geometry, with the combs through-channel being any multisided or rounded shape, with substantially triangular, square, pentagonal, hexagonal, heptagonal, or octagonal, or similar geometries preferred due to ease of manufacturing and increased surface area.

Disposed on and/or throughout the catalyst substrate is a catalyst for converting exhaust gasses to acceptable emissions levels. The catalyst may comprise one or more catalyst materials that are wash coated, imbibed, impregnated, physisorbed, chemisorbed, precipitated, or otherwise applied to the catalyst substrate. Possible catalyst materials include metals, such as platinum, palladium, rhodium, iridium, osmium, ruthenium, tantalum, zirconium, yttrium, cerium, nickel, copper, and the like, as well as oxides, and alloys, and mixtures comprising at least one of the foregoing catalyst materials, and other catalysts.

Located in between the catalyst substrate and a catalytic converter shell is a mat support material that insulates the shell from both the high exhaust gas temperatures and the exothermic catalytic reaction occurring within the catalyst substrate. The mat support material, which enhances the structural integrity of the catalyst substrate by applying compressive radial forces about it, reducing its axial movement, and retaining it in place, is concentrically disposed around the catalyst substrate to form a mat support material/catalyst substrate subassembly.

The mat support material can either be an intumescent material, e.g., one which contains ceramic materials, and other conventional materials such as organic binders and the like, or combinations comprising at least one of the foregoing materials, and a vermiculite component that expands with heating to maintain firm uniform compression, or non-uniform compression, if desired, or a non-intumescent materials, which does not contain vermiculite, as well as materials which include a combination of both. Non-intumescent materials include materials such as those sold under the trademarks “NEXTEL” and “SAFFIL” by the “3M” Company, Minneapolis, Minn., or those sold under the trademark, “FIBERFRAX” and “CC-MAX” by the Unifrax Co., Niagara Falls, N.Y., and the like. Intumescent materials include materials, sold under the trademark “INTERAM” by the “3M” Company, Minneapolis, Minn., as well as those intumescents which are also sold under the aforementioned “FIBERFRAX” trademark, as well as combinations thereof and others.

The mat support material/catalyst substrate subassembly can be concentrically disposed within a shell. The choice of material for the shell depends upon the type of exhaust gas, the maximum temperature reached by the catalyst substrate, the maximum temperature of the exhaust gas stream, and the like. Suitable materials for the shell can comprise any material that is capable of resisting under-car salt, temperature and corrosion. Typically, ferrous materials are employed, such as ferritic stainless steels. Ferritic stainless steels can include stainless steels such as, e.g., the 400-Series such as SS-409, SS439, and SS-441, with grade SS-409 generally preferred.

The catalytic converter shell can be manufactured by one or more techniques, and, likewise, the mat support material/catalyst substrate subassembly can be disposed within the shell using one or more methods. For example, the mat support material/catalyst substrate subassembly can be inserted into a variety of shells, such as both circular and non-circular designs (e.g., oval, elliptical, square, trapezoidal, and the like), using a stuffing cone. The stuffing cone is a device that compresses the mat support material concentrically about the substrate. The stuffing cone then stuffs the compressed mat support material/catalyst substrate subassembly into the shell, such that an annular gap preferably forms between the catalyst substrate and the interior surface of the shell as the mat support material becomes compressed about the catalyst substrate.

In the alternative, for example, the shell can comprise two half-shell components, also known as, and more commonly referred to as a clamshell design. The two half shell components are compressed together about the mat support material/catalyst substrate subassembly, such that an annular gap preferably forms between the catalyst substrate and the interior surface of each half shell as the mat support material becomes compressed about the catalyst substrate.

In another alternative, the shell can also have a non-circular geometry such as oval, oblong, rectangular, trapezoidal, and the like. Such noncircular shell designs can preferably be manufactured by employing a half shell, preferably a die formed clamshell, which, when combined with another half, can form the non-circular desired geometry. The mat support material/catalyst substrate subassembly can be placed within one of the half shells prior to assembly of the catalytic converter. The other half shell can be attached to the half shell containing the mat support material/catalyst substrate subassembly, such that an annular gap preferably forms between the catalyst substrate and the interior surface of each half shell as the mat support material becomes compressed about the catalyst substrate. The half shells can be welded together, preferably using a roller seam welding operation.

Once the catalyst substrate and the supplemental material are disposed within the shell, an exhaust system component can be disposed over one or both ends of the shell. Some possible exhaust system component comprise end cone(s), end plate(s), exhaust manifold(s), connecting pipe(s), exhaust pipe(s), coupling apparatus, flexible coupling apparatus, other exhaust system components, combinations comprising at least one of the foregoing components, and the like. The exhaust system components are then securely attached in operable communication with the shell by riveting, bracketing, sealing, adhering, interlocking, snapping, screwing, adjoining, welding, combinations comprising at least one of the foregoing methods, and the like. Typically, one or more securing devices such as rivets, brackets, sealants, adherents, interlocking mechanisms, snaps, screws, joints, welds, combinations comprising at least one of the foregoing securing devices, and the like, are employed. Preferably, one or more welds are disposed around the outer periphery of the shell in physical contact with the exhaust system component, retainer ring, and shell to provide a gas tight seal.

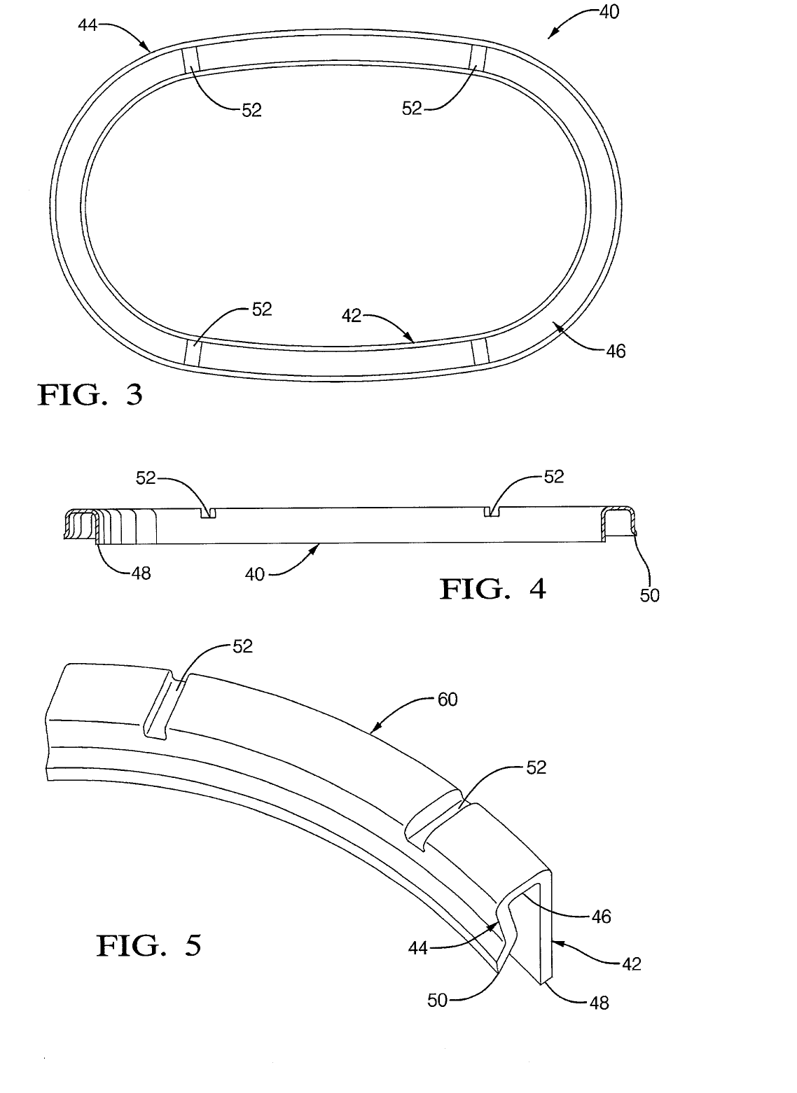

Referring now to FIGS. 3-6, after the catalyst substrate is concentrically disposed within the shell, one or more retainer rings 40, or retainer ring segments 60, can be placed in operable communication with the shell. The retainer ring 40 comprises a substantially U-shaped ring having a first wall 42, comprising an edge 48, and a second wall 44, comprising an edge 50, connected therein by a bridge 46. The second wall 44, which can have a length less than the first wall 42 length, preferably has san edge 50 that is disposed at an angle away from second wall 44 to further facilitate engagement of the retainer ring with the exhaust system component and formation of the fluid tight seal. The edge 48 preferably penetrates the mat support material when the retainer ring 40 is concentrically disposed between the shell and the catalyst substrate. In the alternative, the edge 48 can be sharpened to a pointed edge that can penetrate the mat support material.

The bridge 46, second wall 44, and edge 50 preferably contact the outer surface of the shell, and the wall 44 overlaps at least a portion of the outer surface of the shell to form an interference fit between the retainer ring 40 and shell. As the retainer ring 40 is placed within the shell, at least a portion of the outer surface of the shell interferes with the inner surface of the retainer ring 40, i.e., the outer surface of the shell contacts the inner surface of the second wall 44 and an end of the shell contacts the bridge 46. This interference fit ensures the retainer ring 40 remains in position as an exhaust system component, is placed in operable communication with the shell and retainer ring. The interference fit formed by the shell and retainer ring 40 is especially preferred when employing an exhaust manifold. Since the exhaust manifold extends over both the retainer ring 40 and shell, a weld placed at the juncture of the exhaust manifold, retainer ring and shell will seal the entire assembly.

Optionally, the bridge 46 can further comprise one or more apertures 52, with about 2 to about 6 apertures 52 prefered. The aperture(s) 52 enables the expansion and contraction of the retainer ring 40 as the catalytic converter temperature changes, e.g., from less than about 0° C. up to about 1,200° C.

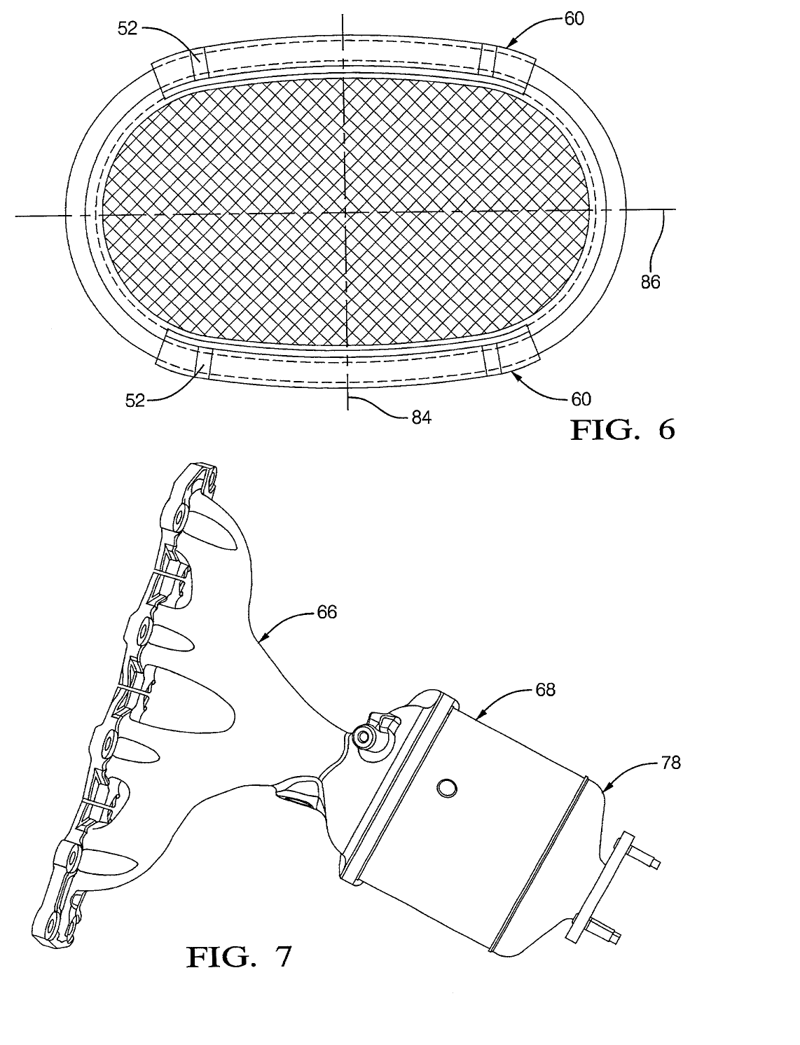

As is shown in FIGS. 5 and 6, the retainer ring may be formed of two or more segments 10 that are each disposed around a portion of the end of the shell, and that may be collectively disposed around all or a portion of the end of the shell. Retainer ring segments 60, as opposed to a unitary retainer ring, can preferably be used in oval shaped catalytic converters, disposed along the major cross-sectional axis 86, due to the potential for growth or expansion of the oval shaped shell across its minor cross-sectional axis 84 during operation and close proximity of the minor axis to the stream of inlet gases.

The dimensions of the retainer ring 40 are dependent upon the size and geometry of the shell and the exhaust system component. Although the retainer ring walls can be of an equal length, the length of the first wall is preferably greater than the length of the second wall to enable ready engagement of the mat support material. Generally, the length of the second wall can be up to about eighty-five percent of the length of the first wall, and preferably up to about seventy-five percent of the length of the first wall, and most preferably up to about sixty percent of the length of the first wall.

With respect to thickness, the retainer ring should have a wall and bridge thickness sufficient to attain the desired structural integrity, preferably to enable easy handling and/or installation, and to minimize cost. The thickness of the walls and the bridge can be equal or different, and is generally up to about 5 millimeters (“mm”) or so for most applications, with up to about 3 mm preferred, and up to about 1 mm more preferred.

The width of the bridge (e.g., the distance between the first wall and the second wall) can be proportioned according to an annulus 80 of the catalytic converter (e.g., the distance measured between the outer surface of the catalyst substrate to the inner surface of the shell). Preferably, the bridge enables the retainer ring to span from the outer surface of the catalyst substrate to the outer surface of the shell, preferably without contacting the catalyst substrate. The width of the bridge can be up to about ninety-five percent of the annulus or so, and preferably up to about ninety percent of the annulus, and most preferably up to about eighty-five percent of the annulus. The apertures disposed in the bridge can have a width of up to about 15 mm, with up to about 10 mm preferred, and up to about 5 mm most preferred.

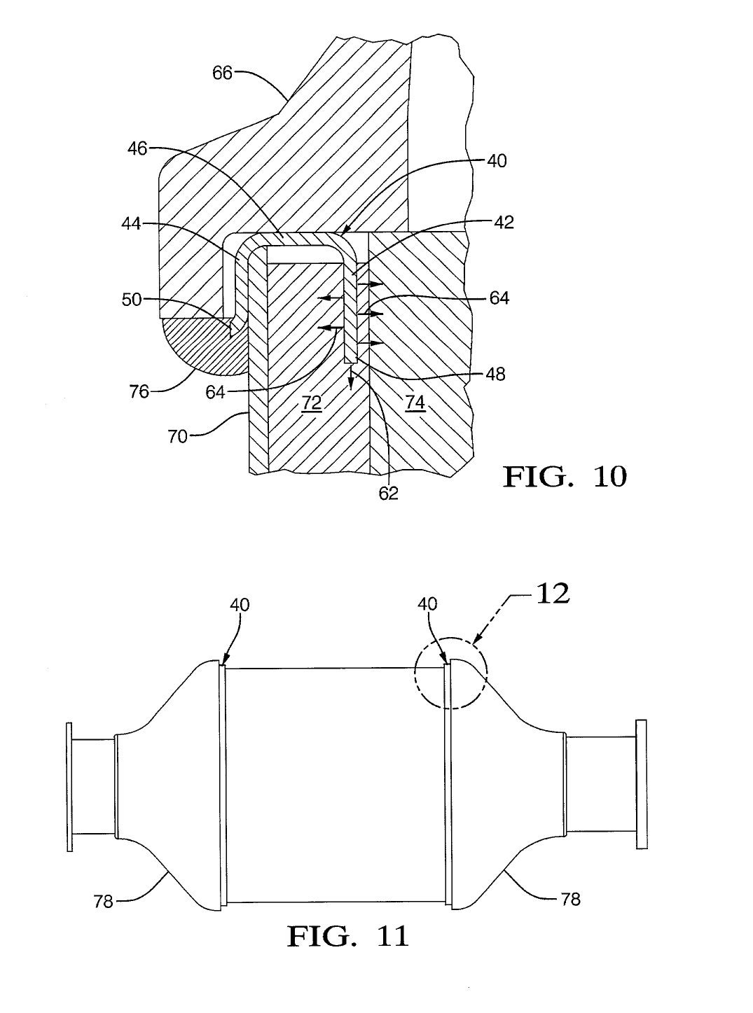

As is illustrated in FIGS. 10 and 11, the first wall 42 is preferably disposed in the shell such that it penetrates the mat support material. Preferably, the first wall 42 penetrates the mat support material a sufficient distance to attain the desired level of protection thereof. The first wall 42 can penetrate the mat support material a distance of up to about eighty percent or so of the length of the first wall 42, and preferably up to about seventy percent of the length of the first wall 42, and most preferably up to about sixty percent of the length of the first wall 42. When the first wall 42 penetrates the mat support material, the mount density of the mat support material increases.

For example, the annulus 80 represents an area filled with compressed mat support material having a mount density of 1 gram per cubic centimeter (“g/cc”). When the first wall 42 of the retainer ring penetrates the mat support material, the first wall 42 first exerts a force in the direction of arrow 62. The area of the annulus decreases due to the insertion of the retainer ring 40. As a result, the first wall 42 of the retainer ring also exerts a force in the direction of arrows 64 upon the mat support material. This additional force causes the mount density of the mat support material disposed on either side of the first wall to increase, e.g., up to about 2.00 g/cc, and preferably up to about 1.60 g/cc, and most preferably up to about 1.2 g/cc.

The retainer rings can comprise any material compatible with the operating conditions, e.g., any deformable metal such as iron, nickel, chromium, alloys such as stainless steel, as well as combinations and alloys comprising at least one of the foregoing materials, and the like, with stainless steels SS-409 and SS-439 preferred.

The retainer ring can be manufactured by first rolling or bending flat stock material into a shape substantially similar to the geometry of the intended catalytic converter and attaching the ends together. The ends can be attached using a weld or other attachment, such as riveting, brazing, and/or mechanical interlocking the ends, overlapping each end of the retainer ring, end over end, and in close proximity with one another, without attaching the ends together. Retainer rings can also be manufactured by cutting a tube of stock material to a desired length and diameter to form a shape substantially similar to the geometry of the intended catalytic converter, e.g., circular, oval, square, trapezoidal, and the like. This alternative method eliminates attaching the ends together. Once the retainer ring's shape is formed, the retainer ring can then be stamped to embody a cross-sectional geometry such as semi-circular, semi-cylindrical, semi-oval, U-shaped, semi-non-circular (e.g., truncated: triangular, square, rectangular, trapezoidal, pentagonal, hexagonal, and the like), and other semi-circular and semi-non-circular cross-sectional geometries, with U-shaped preferred.

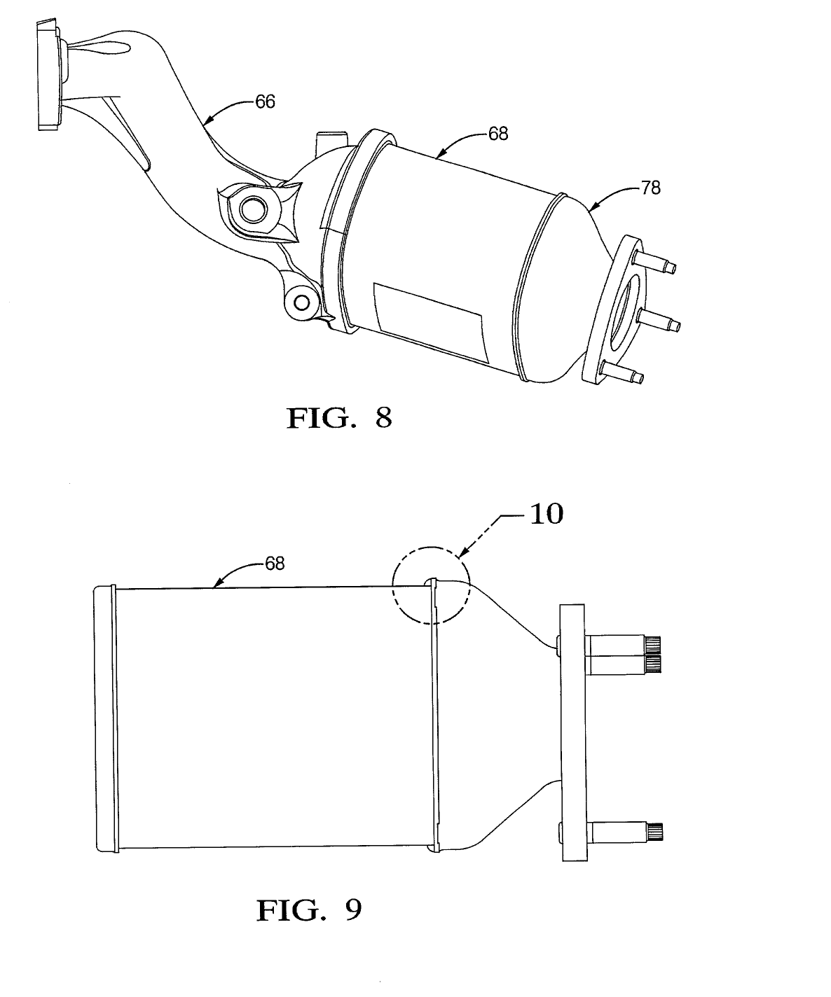

For purposes of illustration, the exemplary retainer rings and retainer rings segments can be employed with exhaust manifold-catalytic converter assemblies and end cone-catalytic converter assemblies. Referring now to FIGS. 7-12, the retainer ring 40 can be used with catalytic converter designs for attachment to exhaust manifolds 66 and/or end cone assemblies 78.

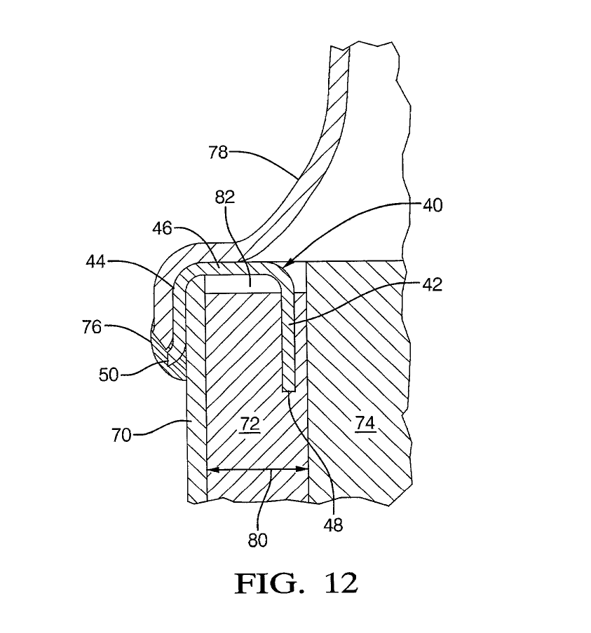

As illustrated in FIGS. 10 and 12, retainer ring 40 can be inserted into a shell 70 to penetrate a mat support material 72 surrounding a catalyst substrate 74 of the catalytic converter 68. In both embodiments that employ the exhaust manifold 66 and end cone assembly 78 respectively, the retainer ring can be placed in operable communication with the shell 70, and preferably the retainer ring 40 and the shell 70 operably communicate to form an interference fit. More preferably, the outer surface of the shell 70 contacts the inner surface of the first wall 42 and bridge 46 of the retainer ring 44 such that second wall 44 of the retainer ring 40 overlaps at least a portion of the outer surface of the shell 70, thus operably communicating with each other to form the interference fit.

Optionally, the retainer ring 40 can be secured within the shell 70, using a weld(s), adhesive, bonding agent, screw(s), snap(s), bracket(s), rivet(s), combinations comprising at least one of the foregoing securing devices, and the like, prior to attachment of the exhaust system component. Once the retainer ring 40 is disposed over and optionally secured to the shell 70, an exhaust system component, such as exhaust manifold 66 or end cone assembly 78, can be placed in operable communication with both the shell 70 and retainer ring 40. The exhaust system component 66, 76 can then be secured to the shell 70 by a weld 76, or the like.

The weld 76 can be a single continuous weld circumferentially positioned about the juncture of the exhaust system component 66, 78 and shell 70 to ensure a fluid tight seal, or can comprise one or more spot welds, where the seal between the retainer ring 40 and shell 70 is relied upon to inhibit fluid movement into or out of the catalytic converter 68. For example, a metal inert gas welding step (“MIG”, also referred to as gas metal arc welding, or “GMAW”) can be used to weld the exhaust manifold 66 or end cone assembly 78, retainer ring 44, and shell 70 together. A single welding step is preferred since the step can be incorporated into the current manufacturing scheme without increasing costs and labor, or impeding manufacturing efficiency. Most preferably, the weld 76 contacts and secures the exhaust system component 66, 78, shell 70, and retainer ring flared edge 50.

The effectiveness of the retainer ring at reducing mat support material erosion can be demonstrated by the following example, which is meant to be exemplary and non-limiting.

### EXAMPLE

A retainer ring was secured in a catalytic converter, which was further secured to an exhaust manifold. Three exhaust manifold-catalytic converter assemblies were assembled. Each exhaust manifold-catalytic converter assembly employing the retainer ring was subjected to a thermal cycling process to test the effectiveness of the retainer ring at preventing mat support material erosion. The thermal cycling process comprised operating the assembly at about 950° C. for a predetermined number of cycles, then decreasing the temperature to about 450° C. for a predetermined number of cycles, and repeating these temperature variations for a predetermined number of cycles for a total of about 250 hours. This thermal cycling process is equivalent to operating the exhaust manifold-catalytic converter assembly for approximately 100,000 miles. Under these conditions, the leading edge of the mat support material in each of the three exhaust manifold-catalytic converter assemblies experienced less than 5% erosion or thermal deterioration.

The exemplary embodiments of the retainer ring provide several distinct advantages such as prevent/reducing exhaust gas impingement upon mat support material and, in turn, mat support material erosion, shell insulation, simplified manufacture and assembly, and the like, over non-retainer ring devices and methods. The retainer rings prevent exhaust gas streams from directly impinging upon the mat support material or the remaining exposed shell. The mat support material and shell will not continuously experience the high temperature exhaust gas stream entering the treatment device because the retainer ring diverts the exhaust gas stream. As a result, the expansion of the mat support material will not erode or deteriorate as quickly as catalytic converters that do not employ retainer rings.

The retainer rings insulate the shell from high temperatures achieved by the exothermic reaction taking place in the catalyst substrate. The retainer rings prevent the shell from experiencing conduction, or the transfer of heat from the catalyst substrate to the shell via the mat support material. This reduces the likelihood and prevents the deformation of the shell. As a result, the retainer rings provide a more efficient and cost effective method for insulating the shell.

Unlike the edge protection materials, the retainer rings can also be incorporated in manufacturing processes. For example, employing wire rope edge sealants requires incorporating several additional steps, including the tedious process of weaving the wire mesh into a strip and adhering the strip to the mat support material; a time and labor intensive process. In contrast, forming and employing the retainer ring is simple. Forming retainer rings or retainer ring segments can be achieved in a single tooling and sizing operation. Inserting the retainer ring can be achieved in a single assembly step and, additionally, welded as part of a single welding step. The retainer ring promotes efficient use of time and labor as well as being cost effective, in the end, to the consumer.

Lastly, the exemplary embodiments of the retainer ring do not add welding steps to the existing catalytic converter assembly process. The ring can be welded in place simultaneously with the shell and exhaust system component, so that no additional welds are required to hold the end ring. This welding process promotes efficiency, requires no additional labor and in the long run is cost effective to consumers.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A gas treatment device, comprising:
a catalyst substrate comprising a catalyst;
a shell concentrically disposed around said catalyst substrate;
a mat support material disposed between said catalyst substrate and said shell, and concentrically around said catalyst substrate;
a retainer ring comprising a first wall and a second wall connected by a bridge, said retainer ring concentrically disposed around said catalyst substrate and in operable communication with said shell to form an interference fit; and
said retainer ring contacts said mat support material.

2. The gas treatment device recited in claim 1, wherein said interference fit further comprises an outer surface of said shell in contact with an inner surface of said second wall and said bridge.

3. The gas treatment device recited in claim 1, wherein said retainer ring further comprises a cross-sectional geometry selected from the group consisting of semi-circular, semi-cylindrical, semi-oval, U-shaped, and semi-non-circular.

4. The gas treatment device recited in claim 1, wherein said retainer ring further comprising at least two segments placed in operable communication with said shell to form an interference fit, wherein said interference fit further comprises an outer surface of said shell in contact with an inner surface of said second wall and a bridge.

5. The gas treatment device recited in claim 4, further comprising an exhaust system component placed in operable communication with said shell and said segments, and wherein said exhaust system component is selected from the group consisting of an exhaust manifold, end cone, connecting pipe, exhaust pipe, coupling apparatus, flexible coupling apparatus, and combinations comprising at least one of the foregoing exhaust system components.

6. The gas treatment device recited in claim 5, wherein said segments are concentrically disposed along a major axis of said shell.

7. The gas treatment device recited in claim 1, further comprising an exhaust system component placed in operable communication with said shell and said retainer ring, and wherein said exhaust system component is selected from the group consisting of an exhaust manifold, end cone, connecting pipe, exhaust pipe, coupling apparatus, flexible coupling apparatus, and combinations comprising at least one of the foregoing exhaust system components.

8. The gas treatment device recited in claim 7, wherein said exhaust system component is placed in operable communication with said shell by a device selected from the group consisting of one or more rivets, brackets, sealants, adherents, interlocking mechanisms, snaps, screws, joints, welds, and combinations comprising at least one of the foregoing devices.

9. The gas treatment device recited in claim 1, wherein said first wall penetrates said mat support material a sufficient distance to engage said mat support material.

10. The gas treatment device recited in claim 1, wherein said bridge further comprises a plurality of apertures.

11. The gas treatment device recited in claim 1, wherein said second wall further comprises an outwardly flared edge.

12. The gas treatment device recited in claim 1, wherein said second wall includes a length that is about eighty percent of a length of said first wall.

13. The gas treatment device recited in claim 1, wherein said bridge includes a width that is about ninety percent of a width of an annulus, wherein said annulus is measured from an outer surface of said catalyst substrate to an inner surface of said shell.

14. A method of manufacturing a gas treatment device, comprising:
disposing a catalyst substrate comprising a catalyst concentrically within a shell;
disposing said mat support material concentrically said catalyst substrate;
disposing a retainer ring in operable communication with said shell to form an interference fit therewith, wherein said retainer ring comprises a first wall that contacts said mat support material, a second wall disposed on a side of said shell opposite said catalyst substrate, and a bridge connecting said first wall and said second wall;
forming an interference fit between said shell and said retainer ring; and
contacting said mat support material with said retainer ring.

15. The method recited in claim 14, wherein said formation of said interference fit further comprises placing an outer surface of said shell in contact with an inner surface of said second wall, and an end of said shell in contact with said bridge.

16. The method recited in claim 14, wherein said first wall penetrates said mat support material a sufficient distance to engage said mat support material.

17. The method recited in claim 14, wherein said retainer ring further comprises at least two segments.

18. The method recited in claim 17, wherein said first wall penetrates said mat support material a sufficient distance to engage said mat support material.

19 The method recited in claim 17, wherein said formation of said interference fit further comprises placing an outer surface of said shell in contact with an inner surface of said second wall, and an end of said shell in contact with said bridge.

20. The method recited in claim 17, further comprising disposing an exhaust system component in operable communication with said shell and said segments, and wherein said exhaust system component is selected from the group consisting of an exhaust manifold, end cone, connecting pipe, exhaust pipe, coupling apparatus, flexible coupling apparatus, and combinations comprising at least one of the foregoing exhaust system components.

21. The method recited in claim 20, further comprising securing said exhaust system component to said shell with a device selected from the group consisting of one or more rivets, brackets, sealants, adherents, interlocking mechanisms, snaps, screws, joints, welds, and combinations comprising at least one of the foregoing devices.

22. The method recited in claim 14, further comprising disposing an exhaust system component in operable communication with said shell and said retainer ring, and wherein said exhaust system component is selected from the group consisting of an exhaust manifold, end cone, connecting pipe, exhaust pipe, coupling apparatus, flexible coupling apparatus, and combinations comprising at least one of the foregoing exhaust system components.

23. The method recited in claim 22, further comprising securing said exhaust system component to said shell with a device selected from the group consisting of one or more rivets, brackets, sealants, adherents, interlocking mechanisms, snaps, screws, joints, welds, and combinations comprising at least one of the foregoing devices.

24. A gas treatment device, comprising:
a catalyst substrate comprising a catalyst;
a shell concentrically disposed around said catalyst substrate;
a mat support material disposed between said catalyst substrate and said shell, and concentrically around said catalyst substrate;
a retainer ring comprising a first wall and a second wall connected therein by a bridge having a plurality of apertures, said retainer ring concentrically disposed around said catalyst substrate, wherein an outer surface of said shell is in contact with an inner surface of said second wall, an end of said shell is in contact with said bridge, and said first wall contacts said mat support material; and
an exhaust system component disposed in operable communication with said shell and said retainer ring.

25. The gas treatment device recited in claim 24, wherein said retainer ring further comprising at least two segments.

26. A gas treatment device, comprising:
means for catalytically treating gas comprising a shell concentrically disposed about a catalyst substrate comprising a catalyst, and a mat support material disposed between said shell and said catalyst substrate, and around said catalyst substrate; and
means for reducing erosion of said mat support material comprising a retainer ring comprising a first wall and a second wall connected by a bridge, wherein said retainer ring is concentrically disposed around said catalyst substrate, in contact with said mat support material, and in operable communication with said shell to form an interference fit.

27. The gas treatment device recited in claim 26, further comprising means for securing said shell to an exhaust system component comprising a device selected from the group consisting of one or more rivets, brackets, sealants, adherents, interlocking mechanisms, snaps, screws, joints, welds, and combinations comprising at least one of the foregoing devices, and wherein said exhaust system component is selected from the group consisting of an exhaust manifold, end cone, connecting pipe, exhaust pipe, coupling apparatus, flexible coupling apparatus, and combinations comprising at least one of the foregoing exhaust system components.
